(19) United States
(12) Patent Application Publication
(10) Pub. No.: US 2015/0274097 A1
(43) Pub. Date: Oct. 1, 2015

(54) APPARATUS FOR PRECONDITIONING A CABIN OF A NON-ELECTRIC VEHICLE USING POWER FROM AN EXTERNAL SOURCE

(71) Applicant: FORD GLOBAL TECHNOLOGIES, LLC, Dearborn, MI (US)

(72) Inventors: Patrick K. Holub, Novi, MI (US); Steven V. B. Lake, Manchester, MI (US); Debasish Dhar, Canton, MI (US)

(73) Assignee: FORD GLOBAL TECHNOLOGIES, LLC, Dearborn, MI (US)

(21) Appl. No.: 14/225,592

(22) Filed: Mar. 26, 2014

(51) Int. Cl. B60R 16/03

(52) U.S. Cl. CPC B60R 16/03

(57) ABSTRACT

An apparatus for preconditioning a cabin of a non-electric vehicle uses power supplied from a source that is external to the vehicle, such as an electrical utility power grid. The non-electric vehicle includes an internal combustion engine, a battery, and an electric machine drive unit that supplies electrical energy to the battery when driven by the internal combustion engine. A mechanically operated preconditioning device is provided that can be driven by the engine when the internal combustion engine is operating and that can be driven by the electric machine drive unit when the internal combustion engine is not operating. An AC/DC converter is adapted to receive electrical energy from an external source and to supply such electrical energy through the battery to power the electric machine drive unit to drive the mechanically operated preconditioning device when the internal combustion engine is not operating.

### BACKGROUND OF THE INVENTION

This invention relates in general to apparatuses for preconditioning a cabin (i.e., a passenger compartment) of a vehicle. In particular, this invention relates to an improved apparatus for preconditioning the cabin of a non-electric vehicle using power that is supplied from a source that is external to the vehicle, such as an electrical power utility grid.

Most vehicles are provided with a cabin within which an operator of the vehicle and any passengers are supported during use. Such vehicles are usually provided with an environmental control system to facilitate the comfort of the driver and passengers regardless of the temperature of the ambient environment surrounding the vehicle. For example, virtually all vehicular environmental control systems include a heater for increasing the cabin temperature above the temperature of a relatively cold ambient environment. Also, most vehicular environmental control systems include an air conditioner for decreasing the cabin temperature below the temperature of a relatively hot ambient environment.

Unfortunately, when the environmental control system of the vehicle is turned off (such as when the vehicle is parked and its engine is turned off), the temperature of the cabin of the vehicle will usually rise or fall quickly in accordance with the temperature of the ambient environment. For example, if the vehicle is parked outside on a hot day and the engine is turned off, the temperature of the cabin of the vehicle will quickly rise. If the sun is shining, the temperature of the cabin of the vehicle may rise well above the temperature of the ambient environment. Conversely, if the vehicle is parked outside on a cold day and the engine is turned off, the temperature of the cabin of the vehicle will quickly fall. In some instances, frost or ice may form on the inner surfaces of windows and mirrors within the cabin of the vehicle. All of these conditions within the cabin of the vehicle can result in an unpleasant experience when a person subsequently enters the cabin of the vehicle for use.

To minimize these unpleasant experiences, it is known to precondition the cabin of the vehicle prior to use. In many instances, such preconditioning is performed by operating the environmental control system of the vehicle for a period of time before the vehicle is actually driven. In battery electric vehicles (i.e., vehicles that use only electrical batteries to generate energy to drive the vehicle) and in hybrid electric vehicles (i.e., vehicles that use a combination of both electrical batteries and internal combustion engines to generate energy to drive the vehicle), mechanically operated preconditioning devices such as air conditioning compressors are usually decoupled from the engine FEAD (if such is provided in the vehicle) by equipping them with dedicated drive motors so preconditioning can be accomplished relatively easily and efficiently by using either grid power through charge plugs or the substantial energy reserves within the high voltage battery to operate the environmental control system without having to turn on the internal combustion engine (if such is provided in the vehicle).

However, in non-electric vehicles (i.e., vehicles that use internal combustion engines to generate energy to drive the vehicle), such preconditioning typically requires that the internal combustion engine of the non-electric vehicle be initially turned on in order to operate the various components of the environmental control system. Consequently, in order to precondition the cabin of the vehicle, the internal combustion engine of the non-electric vehicle must be operated for a certain period of time before it is desired to actually move the vehicle. Many non-electric vehicles are provided with remote starting structures that can be used for this specific purpose. Unfortunately, operating the internal combustion engine for the sole purpose of preconditioning the cabin of the vehicle is undesirable for a variety of reasons including, for example, increased fuel consumption (and its attendant cost), undesirable wear, and increased environmental emissions. Thus, it would be desirable to provide an improved apparatus for preconditioning the cabin of a non-electric vehicle that avoids these disadvantages.

### SUMMARY OF THE INVENTION

This invention relates to an improved apparatus for preconditioning a cabin of a non-electric vehicle using power supplied from a source that is external to the vehicle, such as an electrical utility power grid. The non-electric vehicle includes an internal combustion engine, a battery, and an electric machine drive unit that is driven by the internal combustion engine and that supplies electrical energy to the battery. A mechanically operated preconditioning device is provided that can be driven by the engine when the internal combustion engine is operating and that can be driven by the electric machine drive unit when the internal combustion engine is not operating. An AC/DC converter is provided that is adapted to receive electrical energy from an external source and to supply such electrical energy through the battery to power the electric machine drive to drive the mechanically operated preconditioning device when the internal combustion engine is not operating.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a block diagram of a first embodiment of a portion of a non-electric vehicle including an apparatus for preconditioning a cabin of the non-electric vehicle using power supplied from a source that is external to the vehicle in accordance with this invention.

FIG. 2 is a block diagram of a second embodiment of a portion of a non-electric vehicle including an apparatus for preconditioning a cabin of the non-electric vehicle using power supplied from a source that is external to the vehicle in accordance with this invention.

### DETAILED DESCRIPTION OF THE PREFERRED EMBODIMENTS

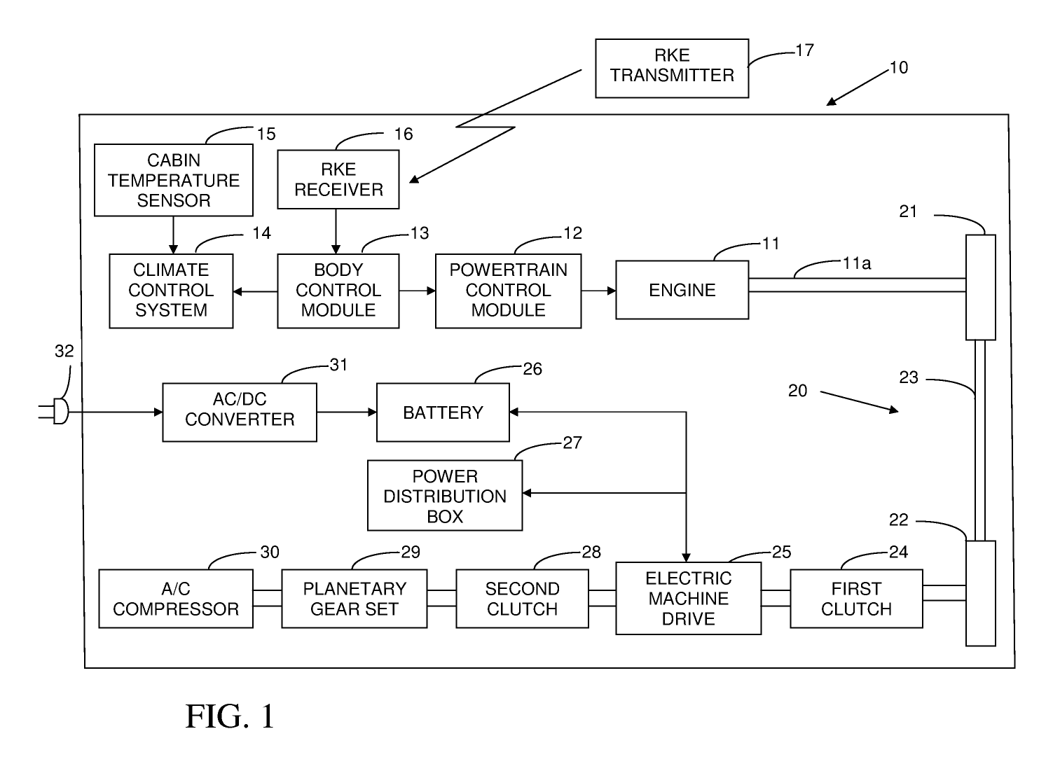

Referring now to the drawings, there is illustrated in FIG. 1 a block diagram of a portion of a first embodiment of a non-electric vehicle, indicated generally at 10, in accordance with this invention. As used herein, the term “non-electric vehicle” is intended to refer to any vehicle that uses only an internal combustion engine to generate energy to drive the vehicle. Thus, the term “non-electric vehicle” is intended to exclude both battery electric vehicles (i.e., vehicles that use only electrical batteries to generate energy to drive the vehicle) and hybrid electric vehicles (i.e., vehicles that use both electrical batteries and internal combustion engines to generate energy to drive the vehicle).

The illustrated non-electric vehicle 10 includes a conventional internal combustion engine 11 that is adapted to generate energy to drive the non-electric vehicle 10 in a conventional manner. The illustrated non-electric vehicle 10 also includes a powertrain control module 12 that is adapted to control, at least in part, the operation of the internal combustion engine 11. The powertrain control module 12 is also conventional in the art and may, for example, be embodied as a microprocessor or other electronic control device that is responsive to one or more input signals for generating one or more output signals to control the operation of the internal combustion engine 11.

The illustrated non-electric vehicle 10 further includes a body control module 13 that is adapted to control, at least in part, the operation of one or more electronic accessories provided within the non-electric vehicle 10 including, among many others, lighting, security, remote keyless entry (RKE), and power door locking accessories (not shown). The body control module 13 is also conventional in the art and may, for example, be embodied as a microprocessor or other electronic control device that is responsive to one or more input signals for generating one or more output signals to control the operation of the various electronic accessories provided within the non-electric vehicle 10.

For example, the illustrated body control module 13 can generate one or more signals to a climate control system 14 that is provided within the non-electric vehicle 10. The climate control system 14 is conventional in the art and includes one or more manually operable controls (not shown) for allowing a user to determine one or more desired environmental conditions for the cabin (i.e., a passenger compartment) of the non-electric vehicle 10. To facilitate this, the climate control system 14 may be responsive to a conventional temperature sensor 15 that is usually provided within the cabin of the non-electric vehicle 10. In response to the signals from the body control module 13, the one or more manually operable controls, and the cabin temperature sensor 15, the climate control system 14 generates one or more signals to control the operation of one or more heating and/or air conditioning accessories (not shown) provided within the non-electric vehicle 10.

Also, the illustrated body control module 13 is responsive to one or more input signals generated from an RKE receiver 16 that is also provided within the non-electric vehicle 10. The RKE receiver 16 is also conventional in the art and is responsive to one or more signals generated by an external remote keyless entry (RKE) transmitter 17 for generating one or more signals to the body control module 13. In response thereto, the body control module 13 controls the operation of one or more power door locking accessories and remote engine start (or remote cabin preconditioning start using this invention) in a conventional manner.

The internal combustion engine 11 includes a crankshaft l la or other rotatably driven output shaft that, in this first embodiment of the invention, is directly connected to rotatably drive a front end accessory drive (FEAD) unit, indicated generally at 20, provided within the non-electric vehicle 10. The FEAD unit 20 is conventional in the art and is provided to connect the internal combustion engine 11 to drive one or more mechanically driven accessories provided within the non-electric vehicle 10. In this first embodiment, the FEAD unit 20 includes a first pulley 21, a second pulley 22, and an endless belt 23 or other connecting member that extends between the first pulley 21 and the second pulley 22. The first pulley 21 is connected to be rotatably driven by the crankshaft 11a. Thus, when the first pulley 21 is rotatably driven by the crankshaft 11a, the second pulley 22 is also rotatably driven.

In the illustrated embodiment, the second pulley 22 is connected through a first clutch 24 to an electric machine drive unit 25. The first clutch 24 is conventional in the art and is adapted to selectively connect the electric machine drive unit 25 to the second pulley 22 such that rotation of the second pulley 22 causes rotation of the electric machine drive 25. The electric machine drive unit 25 may be embodied as any structure that can both (1) convert the mechanical energy provided by the rotation of the second pulley 22 into electrical energy and (2) convert electrical energy into mechanical energy to cause rotation of first clutch 24 and second clutch 28. Such electrical energy can be provided from the electric machine drive unit 25 to either or both of a battery 26 and a power distribution box 27 provided within the non-electric vehicle 10. The battery 26 is conventional in the art and is adapted to store electrical energy therein for use in starting the non-electric vehicle 10 and for operating one or more electrical accessories provided within the non-electric vehicle 10. The power distribution box 27 is also conventional in the art and is adapted to distribute electrical power from the electric machine drive unit 25 directly to the one or more electrical accessories provided within the non-electric vehicle 10. Thus, when the internal combustion engine 11 is operating and the first clutch 24 is engaged, the electric machine drive unit 25 provides electrical energy to both the battery 26 and the power distribution box 27.

In this first embodiment, the electric machine drive unit 25 has an output shaft that is connected through a second clutch 28 to rotatably drive a planetary gear set 29. In turn, the planetary gear set 29 is connected to rotatably drive an air conditioning compressor 30. The second clutch 28 is conventional in the art and is adapted to selectively connect the planetary gear set 29 to be rotatably driven by the electric machine drive unit 25. The planetary gear set 29 is conventional in the art and is adapted to provide a desired gear ratio relationship between the rotational speed of an output shaft of the electric machine drive unit 25 to the input of the air conditioning compressor 30. The illustrated air conditioning compressor 30 is conventional in the art and is adapted to pump a refrigerant through a refrigerant loop (not shown) provided within the non-electric vehicle 10. Thus, when the internal combustion engine 11 is operating and the second clutch 28 is engaged, the air conditioning compressor 30 is rotatably driven so as to provide for the flow of refrigerant within the climate control system of non-electric vehicle 10. However, as explained further below, the illustrated air conditioning compressor 30 is intended to be representative of any other mechanically operated preconditioning device provided within the non-electric vehicle 10, e.g. a FEAD driven water pump.

In this first embodiment, an AC/DC converter circuit 31 is provided within the non-electric vehicle 10 and is electrically connected between the battery 26 and an external plug 32 or other conventional electrical connector. The AC/DC converter circuit 31 may, if desired, be normally supported on the non-electric vehicle 10 as shown in FIG. 1. However, in order to reduce the overall weight of the non-electric vehicle 10 or for other reasons, it may be preferable that the AC/DC converter circuit 31 be provided externally of the non-electric vehicle 10 along with the plug 32. In either event, the AC/DC converter circuit 31 is conventional in the art and is adapted to convert an incoming alternating current (AC) electrical signal to an outgoing direct current (DC) electrical signal.

The plug 32 is preferably supported on the end of a conventional electrical cord that may, if desired, be supported on a conventional retractable spool (not shown) or other device for convenient extension for use and retraction and storage during non-use. The plug 32 is adapted to be extended from the AC/DC converter circuit 31 and the non-electric vehicle 10 and plugged into a conventional wall outlet (not shown) such as is commonly provided in a home garage. Typically, for example, the plug 32 is connected through such a wall outlet to a conventional electrical utility power grid. However, the plug 32 may be plugged into any other source of AC electrical power that is external to the non-electric vehicle 10. In either event, when the plug 32 is plugged in, the AC/DC converter circuit 31 transforms the AC electrical power from the external source into DC electrical power, and further supplies that DC electrical power to the battery 26 of the non-electric vehicle 10. The purpose for providing the non-electric vehicle 10 with the AC/DC converter circuit 31 and the plug 32 will be explained in greater detail below.

As discussed above, it is known to precondition the cabin of the non-electric vehicle 10 prior to use in order to minimize the unpleasant experience of relatively extreme environmental conditions when a user enters the cabin after an extended period of non-operation, particularly when the temperature of the ambient environment about the non-electric vehicle 10 is either hot or cold. However, as discussed above, in prior non-electric vehicles 10, the internal combustion engine 11 had to be operated for a certain period of time before actually moving the non-electric vehicle 10 in order to accomplish this preconditioning. This invention avoids that undesirable manner of preconditioning the cabin of the non-electric vehicle 10 by providing the AC/DC converter circuit 31 and the plug 32.

When it is desired to precondition the non-electric vehicle 10, the plug 32 is connected to the external source of electrical power as described above. When the plug 32 is plugged into the external source of electrical power, the AC/DC converter circuit 31 transforms the incoming AC electrical power into DC electrical power, and further supplies that DC electrical power to the battery 26 of the non-electric vehicle 10. This DC electrical power is then passed through the battery 26 of the non-electric vehicle 10 to operate any desired electrically-operated component of the environmental control system provided within the non-electric vehicle 10. The operation of the electrically-operated component of the environmental control system can be accomplished without usage of the electrical energy stored in the battery 26, which is important because the amount of stored electrical energy in the battery of the non-electric vehicle 10 is typically insufficient for such purposes.

To accomplish this, the DC electrical energy from the AC/DC converter circuit 31 is supplied through the battery 26 to the electric machine drive 25, which converts the DC electrical energy into mechanical energy by causing rotation of the output shaft of the electric machine drive 25. As mentioned above, the output shaft of the electric machine drive 25 is connected through the second clutch 28 and the planetary gear set 29 to rotatably drive the air conditioning compressor 30. As a result, the air conditioner compressor 30 (and any related components connected thereto) are operated using the electrical energy from the external source of electrical power to provide for the flow of refrigerant within the climate control system of the non-electric vehicle 10.

While the air conditioner compressor 30 is being operated in this manner, the first clutch 24 is maintained in either a disengaged condition or an overrunning condition to prevent the second pulley 22 and the remainder of the FEAD unit 20 from being mechanically driven by the electric machine drive 25 during this preconditioning mode of operation. The electrical energy from the external source of electrical power can also be used to operate other (electrical) preconditioning devices within the non-electric vehicle 10 such as, for example, HVAC fans and resistive heating elements. These other preconditioning devices can be operated individually or in conjunction with the operation of the air conditioner compressor 30.

Because the electrical power used to operate all of these preconditioning devices is supplied from the external source of electrical power through the plug 32 and the AC/DC converter circuit 31 to the battery 26, all of the preconditioning of the non-electric vehicle 10 can be accomplished without either (1) operating the internal combustion engine 11 or (2) undesirably draining the amount of energy stored in the battery 26 of the non-electric vehicle 10. Accordingly, the preconditioning of the non-electric vehicle 10 can be accomplished easily and efficiently. When such preconditioning of the non-electric vehicle 10 is completed, the plug 32 is simply removed from the wall outlet and stored within the non-electric vehicle 10 for future use.

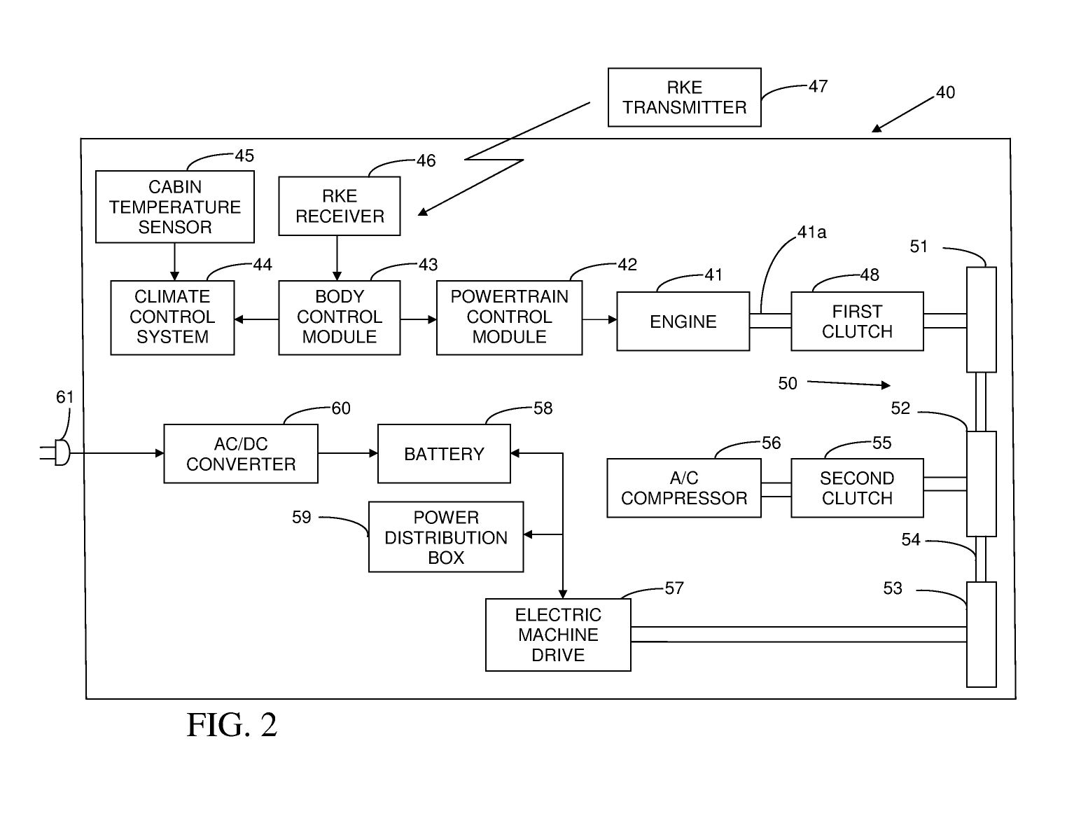

FIG. 2 is a block diagram of a portion of a second embodiment of a non-electric vehicle, indicated generally at 40, in accordance with this invention. The illustrated non-electric vehicle 40 includes a conventional internal combustion engine 41 that is adapted to generate energy to drive the non-electric vehicle 40 in a conventional manner. The illustrated non-electric vehicle 40 also includes a powertrain control module 42 that is adapted to control, at least in part, the operation of the internal combustion engine 41. The powertrain control module 42 is also conventional in the art and may, for example, be embodied as a microprocessor or other electronic control device that is responsive to one or more input signals for generating one or more output signals to control the operation of the internal combustion engine 41.

The illustrated non-electric vehicle 40 further includes a body control module 43 that is adapted to control, at least in part, the operation of one or more electronic accessories provided within the non-electric vehicle 40 including, among many others, lighting, security, remote keyless entry (RKE), and power door locking accessories (not shown). The body control module 43 is also conventional in the art and may, for example, be embodied as a microprocessor or other electronic control device that is responsive to one or more input signals for generating one or more output signals to control the operation of the various electronic accessories provided within the non-electric vehicle 40.

For example, the illustrated body control module 43 can generate one or more signals to a climate control system 44 that is provided within the non-electric vehicle 40. The climate control system 44 is conventional in the art and includes one or more manually operable controls (not shown) for allowing a user to determine one or more desired environmental conditions for the cabin (i.e., a passenger compartment) of the non-electric vehicle 40. To facilitate this, the climate control system 44 may be responsive to a conventional temperature sensor 45 that is usually provided within the cabin of the non-electric vehicle 40. In response to the signals from the body control module 43, the one or more manually operable controls, and the cabin temperature sensor 45, the climate control system 44 generates one or more signals to control the operation of one or more heating and/or air conditioning accessories (not shown) provided within the non-electric vehicle 40.

Also, the illustrated body control module 43 is responsive to one or more input signals generated from an RKE receiver 46 that is also provided within the non-electric vehicle 40. The RKE receiver 46 is also conventional in the art and is responsive to one or more signals generated by an external remote keyless entry (RKE) transmitter 47 for generating one or more signals to the body control module 43. In response thereto, the body control module 43 controls the operation of one or more power door locking accessories and remote engine start (or remote cabin preconditioning start using this invention) in a conventional manner.

The internal combustion engine 41 includes a crankshaft 41a or other rotatably driven output shaft that, in this second embodiment of the invention, is selectively connected through a first clutch 48 to rotatably drive a front end accessory drive (FEAD) unit, indicated generally at 50, provided within the non-electric vehicle 40. The FEAD unit 50 is conventional in the art and is provided to connect the internal combustion engine 41 to drive one or more mechanically driven accessories provided within the non-electric vehicle 40. In this second embodiment, the FEAD unit 50 includes a first pulley 51, a second pulley 52, a third pulley 53, and an endless belt 54 or other connecting member that extends between the first pulley 51, the second pulley 52, and the third pulley 53. The first pulley 51 is connected to be selectively rotatably driven by the crankshaft 41a. Thus, when the first pulley 51 is rotatably driven by the crankshaft 41a, the second pulley 52 and the third pulley 53 are also rotatably driven.

In this second embodiment, the second pulley 52 is connected through a second clutch 55 to an air conditioning compressor 56. The air conditioning compressor 56 is conventional in the art and is adapted to pump a refrigerant through a refrigerant loop (not shown) provided within the non-electric vehicle 40. Thus, when the internal combustion engine 41 is operating and the second clutch 55 is engaged, the air conditioning compressor 56 is rotatably driven so as to provide for the flow of refrigerant within the climate control system of the non-electric vehicle 40. However, as explained further below, the illustrated air conditioning compressor 56 is intended to be representative of any other mechanically operated preconditioning device provided within the non-electric vehicle 40, e.g. a FEAD driven water pump.

Also in this second embodiment, the third pulley 53 is connected to rotatably drive an input shaft of an electric machine drive unit 57. The electric machine drive unit 57 may be embodied as any structure that can both (1) convert the mechanical energy provided by the rotation of the third pulley 53 into electrical energy and (2) convert electrical energy into mechanical energy to cause rotation of the third pulley 53. Such electrical energy can be provided from the electric machine drive unit 57 to either or both of a battery 58 and a power distribution box 59 provided within the non-electric vehicle 40. The battery 58 is conventional in the art and is adapted to store electrical energy therein for use in starting the non-electric vehicle 40 and for operating one or more electrical accessories provided within the non-electric vehicle 40. The power distribution box 59 is also conventional in the art and is adapted to distribute electrical power from the electric machine drive unit 57 directly to the one or more electrical accessories provided within the non-electric vehicle 40. Thus, when the internal combustion engine 41 is operating and the first clutch 48 is engaged, the electric machine drive unit 57 provides electrical energy to both the battery 58 and the power distribution box 59.

In the illustrated embodiment, an AC/DC converter circuit 60 is provided within the non-electric vehicle 40 and is electrically connected between the battery 58 and an external plug 61 or other conventional electrical connector. The AC/DC converter circuit 60 may, if desired, be normally supported on the non-electric vehicle 40 as shown in FIG. 1. However, in order to reduce the overall weight of the non-electric vehicle 40 or for other reasons, it may be preferable that the AC/DC converter circuit 60 be provided external of the non-electric vehicle 40 along with the plug 61. In either event, the AC/DC converter circuit 60 is conventional in the art and is adapted to convert an incoming alternating current (AC) electrical signal to an outgoing direct current (DC) electrical signal.

The plug 61 is preferably supported on the end of a conventional electrical cord that may, if desired, be supported on a conventional retractable spool (not shown) or other device for convenient extension for use and retraction and storage during non-use. The plug 61 is adapted to be extended from the AC/DC converter circuit 60 and the non-electric vehicle 40 and plugged into a conventional wall outlet (not shown) such as is commonly provided in a home garage. Typically, for example, the plug 61 is connected through such a wall outlet to a conventional electrical utility power grid. However, the plug 61 may be plugged into any other source of AC electrical power that is external to the non-electric vehicle 40. In either event, when the plug 61 is plugged in, the AC/DC converter circuit 60 transforms the AC electrical power from the external source into DC electrical power, and further supplies that DC electrical power to the battery 58 of the non-electric vehicle 40. The purpose for providing the non-electric vehicle 40 with the AC/DC converter circuit 60 and the plug 61 will be explained in greater detail below.

When it is desired to precondition the non-electric vehicle 40, the plug 61 is connected to the external source of electrical power as described above. When the plug 61 is plugged into the external source of electrical power, the AC/DC converter circuit 60 transforms the incoming AC electrical power into DC electrical power, and further supplies that DC electrical power to the battery 58 of the non-electric vehicle 40. This DC electrical power is then passed through the battery 58 of the non-electric vehicle 40 to operate any desired electrically-operated component of the environmental control system provided within the non-electric vehicle 40. The operation of the electrically-operated component of the environmental control system can be accomplished without usage of the electrical energy stored in the battery 58, which is important because the amount of stored electrical energy in the battery of the non-electric vehicle 40 is typically insufficient for such purposes.

To accomplish this, the DC electrical energy from the AC/DC converter circuit 60 is supplied through the battery 58 to the electric machine drive 57, which converts the DC electrical energy into mechanical energy by causing rotation of the input shaft of the electric machine drive 57. As mentioned above, the input shaft of the electric machine drive 57 is rotatably connected to the third pulley 53 of the FEAD unit 50. Thus, rotation of the input shaft of the electric machine drive 57 causes rotation of the second pulley 52 to rotatably drive the air conditioning compressor 56 when second clutch 55 is engaged. As a result, the air conditioner compressor 56 (and any related components connected thereto) are operated using the electrical energy from the external source of electrical power to provide for the flow of refrigerant within the climate control system of non-electric vehicle 40.

Rotation of the input shaft of the electric machine drive 57 also causes rotation of the first pulley 51. While the air conditioner compressor 56 is being operated in the manner described above, the first clutch 48 is maintained in either a disengaged condition or an overrunning condition to prevent the internal combustion engine 41 from being mechanically driven by the first pulley 51 during this preconditioning mode of operation. The electrical energy from the external source of electrical power can also be used to operate other (electrical) preconditioning devices within the non-electric vehicle 40 such as, for example, HVAC fans and resistive heating elements . These other preconditioning devices can be operated individually or in conjunction with the operation of the air conditioner compressor 56.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A vehicle comprising:
an engine;
a battery;
an electric machine driven by the engine and supplying energy to the battery;
a preconditioning device driven by the engine when it is operating and driven by the electric machine when it is not operating; and
an AC/DC converter receiving energy from an external source and supplying such energy through the battery to power the electric machine to drive the preconditioning device when the engine is not operating.

2. The vehicle defined in claim 1 wherein the internal combustion engine rotatably drives a pulley, and wherein the pulley is connected to a second pulley which is connected through a clutch to rotatably drive the electric machine drive unit.

3. The vehicle defined in claim 2 wherein the clutch allows the pulley to drive the electric machine drive unit but selectively allows the electric machine drive unit to drive the pulley.

4. The vehicle defined in claim 3 wherein the clutch is a first clutch, and wherein the electric machine drive unit is connected through a second clutch to rotatably drive the mechanically operated preconditioning device.

5. The vehicle defined in claim 2 wherein the AC/DC converter is supported on the electric vehicle.

6. The vehicle defined in claim 2 wherein the AC/DC converter is provided externally of the electric vehicle.

7. The vehicle defined in claim 1 wherein the internal combustion engine is connected through a clutch to rotatably drive a pulley, and wherein the pulley rotatably drives the electric machine drive unit.

8. The vehicle defined in claim 7 wherein the clutch allows the internal combustion engine to drive the pulley but selectively allows the pulley to drive the internal combustion engine.

9. The vehicle defined in claim 1 wherein the AC/DC converter is supported on the electric vehicle.

10. The vehicle defined in claim 1 wherein the AC/DC converter is provided externally of the electric vehicle.

11. A non-electric vehicle comprising:
an internal combustion engine;
a battery;
an electric machine drive unit that is driven by the internal combustion engine and that supplies electrical energy to the battery;
a mechanically operated preconditioning device that can be driven by the engine when the internal combustion engine is operating and that can be driven by the electric machine drive unit when the internal combustion engine is not operating; and
an AC/DC converter that is adapted to receive electrical energy from an external source and to supply such electrical energy through the battery to power the electric machine drive to drive the mechanically operated preconditioning device when the internal combustion engine is not operating.

12. The non-electric vehicle defined in claim 11 wherein the internal combustion engine rotatably drives a pulley, and wherein the pulley is connected to a second pulley which is connected through a clutch to rotatably drive the electric machine drive unit.

13. The non-electric vehicle defined in claim 12 wherein the clutch allows the pulley to drive the electric machine drive unit but selectively allows the electric machine drive unit to drive the pulley.

14. The non-electric vehicle defined in claim 13 wherein the clutch is a first clutch, and wherein the electric machine drive unit is connected through a second clutch to rotatably drive the mechanically operated preconditioning device.

15. The non-electric vehicle defined in claim 12 wherein the AC/DC converter is supported on the non-electric vehicle.

16. The non-electric vehicle defined in claim 12 wherein the AC/DC converter is provided externally of the non-electric vehicle.

17. The non-electric vehicle defined in claim 11 wherein the internal combustion engine is connected through a clutch to rotatably drive a pulley, and wherein the pulley rotatably drives a third pulley which drives the electric machine drive unit.

18. The non-electric vehicle defined in claim 17 wherein the first clutch allows the internal combustion engine to drive the pulley but selectively allows the pulley to drive the internal combustion engine.

19. The non-electric vehicle defined in claim 11 wherein the AC/DC converter is supported on the non-electric vehicle.

20. The non-electric vehicle defined in claim 11 wherein the AC/DC converter is provided externally of the non-electric vehicle.
